(19) United States
(12) Patent Application Publication
(10) Pub. No.: US 2024/0405304 A1
(43) Pub. Date: Dec. 5, 2024

(54) Process for Recovery of Battery Cathode Metal Oxides And Copper From The Wastes

(71) Applicant: INDIAN INSTITUTE OF TECHNOLOGY KHARAGPUR, Kharagpur (IN)

(72) Inventors: Chenna Rao Borra, Kharagpur (IN); Arundhati Jena, Kharagpur (IN); Saida Shaik, Kharagpur (IN)

(21) Appl. No.: 18/675,922

(22) Filed: May 28, 2024

(30) Foreign Application Priority Data
May 30, 2023 (IN) 202331037351

(51) Int. Cl. H01M 10/54; C22B 3/00; C22B 3/22; C22B 3/44; C22B 3/46; C22B 7/00; C22B 26/12; C22B 47/00

(52) U.S. Cl. CPC H01M 10/54; C22B 3/22; C22B 3/44; C22B 3/46; C22B 7/001; C22B 7/007; C22B 23/0415; C22B 23/0461; C22B 26/12; C22B 47/00

(57) ABSTRACT

A process for recovery of at least one transition metal including selected Ni, Co and Mn and lithium from waste of lithium ion batteries comprising the steps of, subjecting at least a part of said waste of lithium ion batteries including said transition metal in trivalent state to reductive leaching in mineral/organic acids in presence of copper as reductant in the temperature range of 0-100° C. for 5 mins to 12 hrs; and thereafter, following said leaching step by solid liquid separation to remove the undissolved materials to get the clear leach solution of anyone or more of Li, Ni, Co, Mn and Cu for desired recovery therefrom. The process pertains specifically to reductive leaching of a portion of the black mass of the waste lithium ion batteries with copper and selectively reducing the remaining portion of said black mass at high temperature followed by cementation of copper with the metals present in the reduced mass in an energy-efficient and cost-effective technique compared to the conventional high temperature reduction. The reduction step can be avoided by removing the copper from solution either by selective crystallization of copper, or selective Electrowinning of copper or by use of Ni/Co containing scrap.

### CROSS-REFERENCE TO RELATED APPLICATION

This application claims priority from Indian patent application Ser. No. 20/233,1037351 filed on May 30, 2023, the entire disclosures of which are part of the disclosure of the present application and are hereby incorporated by reference in their entireties.

### FIELD OF INVENTION

The present invention relates to an advanced process for the recovery of battery cathode metal oxides and copper from spent lithium ion batteries or production waste containing at least one of the transition metals nickel, manganese and cobalt. The process pertains specifically to the reductive leaching of a portion of the black mass of the cathode material with copper and selectively reducing the remaining portion of said black mass of said cathode material at high temperature in an energy-efficient and cost-effective technique without requiring expensive reagents compared to the conventional high temperature reduction followed by leaching process. The present invention also relates to the reductive leaching of the black mass of the cathode material with copper followed by recovery of copper by using different cost effective techniques.

### BACKGROUND ART

Recycling of Lithium Ion Batteries is not only eco-friendly but also generates valuable raw materials required for production of new batteries. Generally, elements present in the black mass which is obtained from the cathode of the batteries, are recovered and purified through hydrometallurgical route. Co and Mn are present as higher oxides in the black mass, which are difficult to leach. They are converted to lower oxide with a prior high temperature reduction followed by leaching or with the addition of reductants such as FeSO₄, Cu and H₂O₂ during leaching.

Said high temperature reduction with reducing agents such as carbon, plastics or hydrogen etc. is energy intensive and increases the cost of the process. The reductive leaching increases the impurity concentration in the leach solution except H₂O₂. However, H₂O₂ is not a stable reagent and expensive. Hence, the consumption of H₂O₂ is higher and also the reaction is not complete. which decreases the recovery and also increases the process cost.

Porvali et. al. (Hydrometallurgy 195, (2020), 105408) studied the dissolution of black mass in a low acid leaching using Fe²⁺ as reducing agent for LiCoO₂ (LCO) and Cu as a reducing agent for Fe³⁺. In this process, contamination takes place as Fe and Cu comes into the solution, therefore requires additional process steps for purifification of the desired transitional metal ions obtained from said solution mixture. A prior patent CN113801999A discloses a process for reducing and leaching a lithium battery positive electrode material by using ferronickel powder. The cathode and anode powder underwent high temperature roasting and then leached with sulfuric acid. Active Ni powder was added to the primary acid leaching residue containing higher oxides to perform reduction acid leaching. The problem associated with this process is generated from roasting of all the black mass, which is energy intensive. Furthermore, expensive Ni as a reductant is added, which is not a stable metal in acid solution and leads to evolution of H₂ which leaves the system without completely reacting with higher oxides, thus leading to consumption of more nickel and decreased efficiency of the process.

Therefore requirement of an alternative process for the recovery and purification of battery cathode metal oxides from spent lithium ion batteries or production waste is felt to enable an energy-efficient technique for recycling of Lithium Ion Batteries.

### OBJECTS OF THE INVENTION

It is thus the primary objective of the present invention to provide a process for the recovery of lithium and other metals by avoiding the usage of unstable and expensive H₂O₂, instead involving more economical reducatnt, Cu to reduce cost and number of process steps thus enabling more economic process compared to the existing techniques which require expensive reagents.

It is another objective of the present invention to develop a process for the recovery of lithium and other metals from spent lithium ion batteries or production waste containing at least one of the transition metals nickel, manganese and cobalt in an energy-efficient and cost-effective technique.

Another objective of the present invention is to develop a process for the recovery of lithium and other metals by involving high temperature reduction of a select portion of the cathode material from spent lithium ion batteries or production waste to reduce energy consumption compared to the conventional high temperature reduction followed by leaching process.

It is further objective of the present invention is to develop a process for the recovery of lithium and other metals involving easy recovery steps for the reducing agent copper to be recycled for use in the leaching step also enabling for recycling spent Lithium Ion Batteries effectively by producing the recovered salts suitable for new battery manufacturing.

### SUMMARY OF INVENTION

In first aspect of the present invention is provided a process for recovery of any one or more of transition metal including selected Ni, Co and Mn and also lithium from waste of lithium ion batteries wherein said recovery of any one or more of transition metal including selected Ni, Co and Mn is carried out following the steps comprising:

subjecting selectively about 20-80% of the said waste of lithium ion batteries including said transition metal in trivalent state to reductive leaching in mineral/organic acids in presence of copper as reductant in the temperature range of 0 to 100° C. for 5 minutes to 12 hours; and

thereafter, following said leaching step by solid liquid separation to remove the undissolved materials, if any to get the clear leach solution of anyone or more of Li, Ni, Co, Mn and containing Cu for desired recovery of the transition metal therefrom.

In another aspect of the present invention is provided said process comprising carrying out reductive leaching on a remaining part of the said waste of lithium ion batteries comprises carrying out on a part of the said waste of lithium ion batteries high temperature reduction where said part of black mass is heated to a temperature in the range from 200 to 1100° C. for duration from 5 min to 12 hours using solid or gaseous reductants, thereby converting the trivalent transition metal oxides to recoverable transition metal therefrom and further water leaching of the reduced mass to recover lithium carbonate or hydroxide present in the reduced mass.

In further aspect of the present invention is provided the process comprising step of recovery of copper used as the reductant from the generated leach solution containing the transition metals following said copper based reductive leaching, the residue of said water leaching is treated with said leach solution for desired cementation of the residue carried out at room temperature to 100° C. for a duration of 5 min to 12 hours, the said cementation step carried out below pH 5,preferable below pH 3 to avoid copper hydrolysis and also to promote the dissolution of MnO present in the residue.

In yet further aspect of the present invention is provided the process comprising the steps of,

a) Reductive leaching of part of said waste of lithium ion batteries cathode material with mineral or organic acids in presence of metallic copper to reduce the transition metals including Ni, Co, Mn in the cathode material from higher oxidation state to 2+ state, followed by separating the undissolved solids after leaching by subjecting said solids to a solid-liquid separation to recover pregnant solution;

b) Reducing the remaining part of the said waste of lithium ion batteries cathode material with reducing agents such as carbon and/or hydrogen containing materials at high temperature, followed by subjecting the resultant reduced material to water leaching in presence or absence of CO₂ purging to generate slurry for recovery of lithium out of said slurry through solid-liquid separation resulting to lithium containing solution and solid containing metallic nickel and/or cobalt and MnO;

c) Reacting the pregnant solution generated from step (a) with said solid generated from the step (b) to cement out or remove the copper from said pregnant solution and also enabling recovery of dissolved Ni, Co and Mn obtained from step (b) in the form of corresponding metal salts.

In another aspect of the present invention is provided the process comprising reductive leaching of selectively about 20-80% of the black mass of said waste of lithium ion batteries cathode material in the presence of more economical reductant anode copper or copper scrap as a reductant from the battery and thereafter, reducing selectively of the remaining 20-80% of said black mass of waste of lithium ion batteries cathode material at high temperature to decrease the energy consumption compared to the conventional high temperature reduction followed by leaching process.

In further aspect of the present invention is provided the process comprising the steps of,

(a) reductive leaching of selectively about 60% of the black mass of said waste of lithium ion batteries cathode material in mineral/organic acids in presence of copper in the temperature range of 0 to 100° C. for 5 minutes to 12 hours to reduce the transition metals including Ni, Co, Mn in said cathode material from higher oxidation state to 2+ state, followed by removal of the undissolved materials through solid liquid separation technique, to obtain the clear leach solution containing Li, Ni, Co, Mn and/or Cu.

(b) in a high temperature carbothermic reduction step, the remaining 40% of said black mass of said waste of lithium ion batteries is heated to a temperature in the range from 200 to 900° C. for duration from 5 min to 12 hours in presence of solid or gaseous reductants to convert the trivalent transition metal oxides to divalent or zero-valent transition metals required for step (c).

followed by subjecting the resultant reduced material to water leaching in presence or absence of CO2 purging to generate slurry for recovery of lithium out of said slurry through solid-liquid separation resulting to lithium containing solution and solid containing metallic nickel and/or cobalt and MnO;

(c) in cementation step, the leach solution from step (a) is treated with the residue obtained from step (b) to recover the copper;

wherein, said cementation process is carried out at room temperature to 100° C. for a duration of 5 min to 12 hours at pH of below 5 to avoid copper hydrolysis and also to promote the dissolution of MnO present in the residue of step (b);

wherein after said cementation, copper can be removed by solid-liquid separation step providing more than 98% recovery of Li and said transition metals Ni, Co and Mn from the black mass;

wherein said cementation step, cementation can be carried out with any nickel and/or cobalt containing materials/scrap;

wherein said reduction roasting of only 40% of said black mass of waste of lithium ion batteries saves 60% of energy requirement compared to the conventional high temperature reduction followed by leaching process.

In further aspect of the present invention is provided the process wherein said high temperature carbothermic reduction step involves solid or gaseous reductants including carbohydrates, hydrocarbons, hydrogen, coal, coke.

In another aspect of the present invention is provided the process wherein copper can be recovered from the solution obtained after reductive leaching step by selective crystallization of copper sulfate crystals by evaporating water or by selective Electrowinning by maintaining the voltage below 3.5 V.

In another aspect of the present invention is provided the process wherein copper can be recovered from the solution obtained after reductive leaching step by cementation with any nickel and/or cobalt containing materials/scrap;

Wherein said Nickel/cobalt containing materials/scrap is selected from the sources including nickel/cobalt recovered from Li-ion batteries, nickel/cobalt containing scrap such as mu metal, Sm—Co magnet, maraging steel, pharmaceutical or petrochemical catalysts or any other nickel/cobalt containing materials.

In further aspect of the present invention is provided the process wherein the cemented copper can be involved in reductive leaching step as a reductant and/or can be purified by smelting-refining or other conventional processes.

In yet further aspect of the present invention is provided the process wherein Ni, Co, Mn and Li are recovered from the resultant solution by conventional purification processes including precipitation, solvent extraction, ion exchange.

In another aspect of the present invention is provided the process wherein the copper reductant involved in reductive leaching step is selected from the sources including copper from Li-ion batteries, copper generated by cementation step, copper powder, copper containing alloys, PCBs, electronic waste or any other copper containing materials.

In further aspect of the present invention is provided the process wherein the black mass comprising of particulate material provided is obtained from lithium containing transition metal (Ni, Co, Mn) oxide material having the chemical formula: LiMO₂ or Li₂O.M₂O₃ and wherein said material may stem from lithium ion batteries (battery waste), including spent batteries, waste battery material from production and off-spec material and also materials containing lithium and said transition metals.

The details of the invention its objects and advantages are explained hereunder in greater detail in relation to non-limiting exemplary embodiments in relation to the following accompanying figures:

### BRIEF DESCRIPTION OF THE NON-LIMITING ACCOMPANYING FIGURES OF THE INVENTION

FIG. 1 shows the flow chart of the energy-efficient process for the recovery of battery cathode metal oxides and copper from a cathode material from waste lithium ion batteries according to the present invention including various purification techniques for the isolation of lithium and the transition metal compounds.

FIG. 2 shows materials obtained at different stages of the present process.

FIG. 3 shows SEM and EDAX data of the cemented Cu obtained by the present process.

FIG. 4 shows electrodeposited copper recovered by the present process.

### DETAILED DESCRIPTION OF INVENTION

The present invention is directed towards a process for the recovery of lithium and other metals from spent lithium ion batteries or production waste containing at least one of the transition metals nickel, manganese and cobalt; the process pertains specifically to the reductive leaching of cathode material with Copper.

The cathode material of spent batteries the so called black mass or black powder constitutes the feed for subsequent hydrometallurgical process step. It is the objective of the present invention to provide an economic process to avoid the expensive reagents or reducing/minimizing the number of expensive and/or energy consuming steps.

Accordingly, the process as defined at the outset has been found, hereinafter also referred to as recycling process. The process of the invention comprises steps defined in more detail below, hereinafter also referred to as step (a), step (b), step (c), step (d) etc.

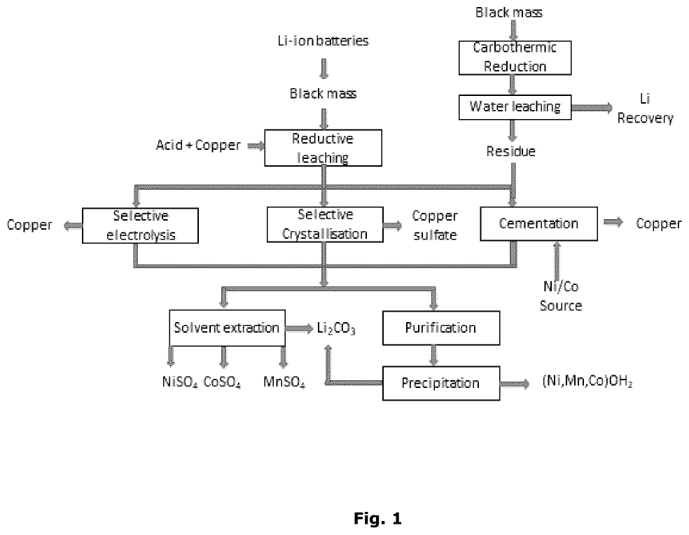

The invention thus primarily pertains to a process for the recovery of one or more transition metals and lithium as Li-salt from a material comprising waste lithium ion batteries, which comprises the steps of
a) Leaching of cathode material with mineral or organic acids in presence of metallic copper to reduce the transition metals, i.e., Ni, Co, Mn in the cathode material from higher oxidation state to 2+ state. Separating the undissolved solids after leaching by subjecting said solids to a solid-liquid separation to recover pregnant solution.
b) Part of the cathode material is also subjected to reduction with reducing agents such as carbon and/or hydrogen containing materials. The reduced material is subjected to water leaching in presence or absence of CO₂ purging to recover lithium; the slurry generated in this process is subjected to solid-liquid separation to get lithium containing solution and solid containing metallic nickel and/or cobalt and MnO.
c) The pregnant solution generated from step (a) is treated with the solid generated from the step (b) to cement out or remove the copper from the pregnant solution and also dissolve the Ni, Co and Mn obtained from step (b) as shown in FIG. 1.

The particulate material provided in step (a) is obtained from lithium containing transition metal (Ni, Co, Mn etc.) oxide material, which material may stem from lithium ion batteries (battery waste), including spent batteries, waste battery material from production and off-spec material and further materials containing lithium and said transition metals.

The particulate material, from now onwards written as black mass, contains Lithium and transition metals (M) with the following chemical formula: LiMO₂ or Li₂O.M₂O₃. The transition metal in the said material is in trivalent state, which is difficult to dissolve completely in an acidic solution. Hence, it is reduced to divalent state by high temperature reduction conventionally before the leaching or with the help of a reducing agent such as H₂O₂, SO₂ etc. during the leaching in conventional methods as per the following chemical reaction.

Li₂O.M₂O₃+H₂/C/CO/CₓH_{y}/CₓH_{y}O_{z}=Li₂O/Li₂CO₃+MO/M+CO/CO₂2/H₂O (1)

Li₂O.M₂O₃+H₂O₂+H₂SO₄=Li₂SO₄+2MSO₄+H₂O (2)

The said conventional high temperature reduction is an energy intensive process and reductive leaching process requires expensive reagents or comprising number of processing steps. Furthermore, H₂O₂ is an unstable compound, hence it consumption increases during the process. To overcome the issue of H₂O₂ and other reductants during leaching in the prior techniques, part of the black mass can be reduced to Co and Ni metals and these metals can be used as reductants during leaching of black mass according to the following chemical equation.

Li₂O.M₂O₃+Ni/Co+H₂SO₄=Li₂SO₄+3MSO₄+4H₂O (3)

However, the efficiency will be low as the metallic Ni and Co dissolves in the leach solution without completely participating in the reduction of the trivalent transition metals to divalent state by liberating hydrogen gas according to the following chemical equation.

Ni/Co+H₂SO₄=(Ni/Co)SO₄+H₂ (4)

Therefore, in the current invention, copper was used as a reductant in the step (a).

Li₂O.M₂O₃+Cu+4H₂SO₄=Li₂SO₄+2MSO₄+CuSO₄+4H₂O (5)

The step (a) of the present process as shown in FIG. 1, consists of leaching the black mass in mineral/organic acids in presence of copper in the temperature range of 0 to 100° C. for 5minutes to 12 hours. The leaching step is followed by solid liquid separation to remove the undissolved materials, if any to get the clear solution containing Li, Ni, Co, Mn and/or Cu.

The copper reductant used in leaching of step (a) could be copper from Li-ion batteries, copper generated from step (c), copper powder, copper containing alloys, PCBs or any other copper containing materials.

The step (b) of the present process as shown in FIG. 1, is a high temperature reduction step where part of black mass is heated to a temperature in the range from 200 to 900° C. for duration from 5 min to 12 hours using solid or gaseous reductants, e.g. carbohydrates, hydrocarbons, hydrogen, coal, coke etc. within the scope of the present invention. The reduction step is carried out to convert the trivalent transition metal oxides to divalent or zero-valent transition metals, which is required for step (c).

Li₂O.M₂O₃+H₂/C/CO/CₓH_{y}/CₓH_{y}O_{z}=Li₂O/Li₂CO₃+MO/M+CO/CO₂/H₂O (6)

In the said high temperature reduction step, the transition metals from the black mass are converted to Ni, Co and MnO. The lithium carbonate or hydroxide present in the reduced mass can be selectively recovered by water leaching. CO₂ purging is an option to enhance the leaching of lithium from the reduced mass. After solid-liquid separation lithium can be recovered from the solution by conventional processes. The water leach residue is sent to step (c) for the removal of copper from the clear solution obtained from step (a) by cementation process.

In this present process of the invention, only about 40% of the black mass needs to be reduced at high temperature in step (b) that markedly decreases the energy consumption compared to the conventional high temperature reduction followed by leaching process. The rest of 60% black mass is leached in the step (a) in the presence of copper as a reductant.

Step (c) consists of removal/regeneration of the copper from the leach solution obtained from step (a) [FIG. 1]. The copper present in the leach solution need to be removed before recovering other transition metals, which is a necessary step for the recovery of pure Ni, Co and Mn salt/compound/metals from the solution. However, complete removal of copper from the leach solution from step (a) is difficult and it increases the number of steps in the process for the recovery of other transition metals from the solution, which makes the overall process expensive.

The leach solution from step (a) is treated with the residue obtained from step (b) to remove/recover/regenerate the copper according to the following chemical reaction.

Ni/Co+CuSO₄=(Ni/Co)SO₄+Cu (7)

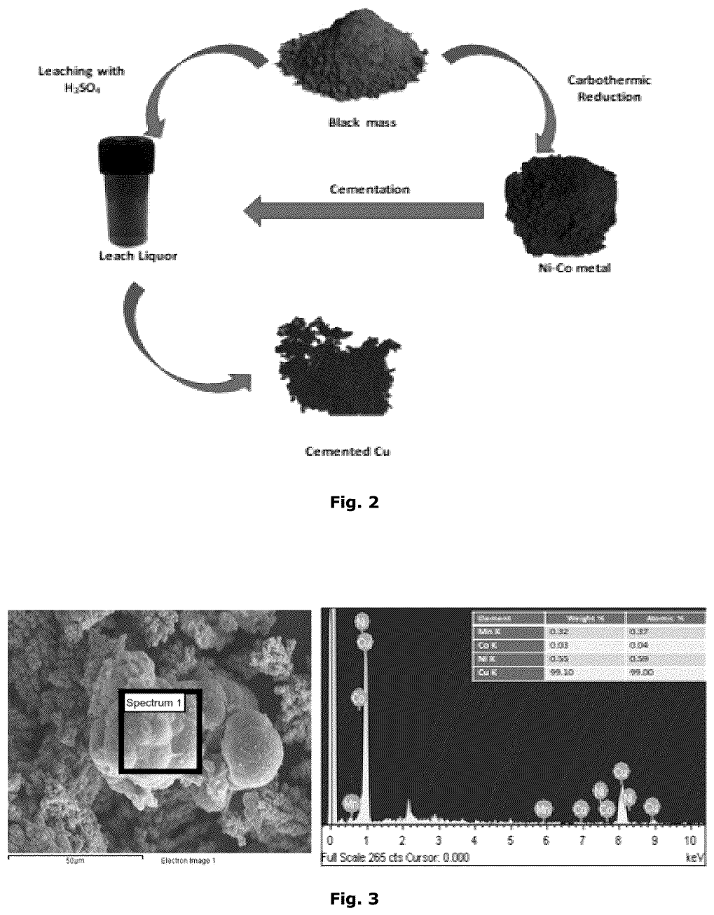

The cementation process at step (c) can be carried out at room temperature to 100° C. for a duration of 5 min to 12 hours. The cementation step need to be carried out below 5 pH, preferable below 3 pH to avoid copper hydrolysis and also to promote the dissolution of MnO present in the residue of step (b). After cementation, copper can be removed by solid-liquid separation step. This cemented copper can be used in step (a) as a reductant or it can be purified by smelting-refining or other conventional processes. Materials obtained at different stages of the present process are demonstrated in FIG. 2.

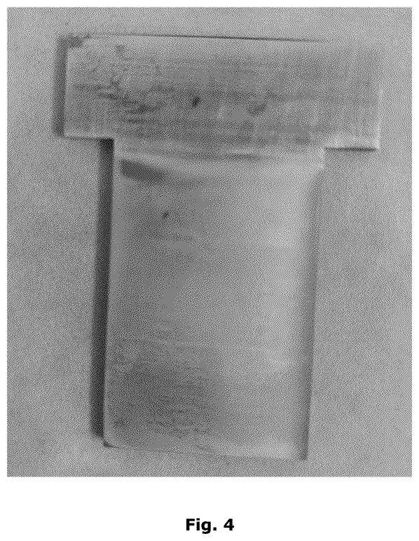

In another embodiment, the solution obtained after leaching step (a) containing copper can be recovered by selective crystallization of copper sulfate crystals by evaporating water or by selective Electrowinning by maintaining the voltage below 2.5V as illustrated in FIGS. 1 and 4.

The solution obtained from step (c) can be further purified by conventional processes such as precipitation, solvent extraction, ion exchange etc. as shown in FIG. 1. The solution(s) obtained after purification can be used for the recovery of Ni, Co, Mn and Li recovery. The pure solution can also directly be used for the cathode material synthesis after maintaining the required ratio of Ni:Co:Mn by addition of pure salts. After maintaining the required ratio, the mixed hydroxide can be co-precipitated to get the NiₓCo_{y}Mn_{z}(OH)₂. The lithium from the solution after removal of Ni, Mn and/or Co can be selectively recovered by treating with sodium carbonate or some other existing processes. The precipitated hydroxide (NiₓCo_{y}Mn_{z}(OH)₂) can be calcined in presence of recovered lithium carbonate/hydroxide to regenerate the cathode material.

The process of the present invention decreases the energy consumption by decreasing the amount of material needed to be processed at high temperature. Furthermore, this process increases the efficiency of reductive leaching of higher oxides present in the black mass. The leach solution obtained after stage (c) in this process is free from impurities such as Cu and organic reductants. More than 98% of Li and transition metals can be recovered from the black mass by this process.

In the present process of the invention, if the pyrolysed PCB was used as a reductant then the residue will be rich in gold and other precious metal. Then the residue can be sent for smelting followed by refining for the recovery of precious metals or other conventional processes.

The present invention relates to the recovery of critical metals from spent Lithium Ion Batteries using 40% energy. The present work avoids the usage of H₂O₂ as it is not stable and expensive, instead, more economical reducatnt, Cu from the anode of the battery is used as reductant. In this process, only 40% of the black mass is reduced at high temperature that decreases the energy consumption. The rest of 60% black mass is leached in the presence of anode copper or copper scrap as a reductant. The leach solution generated after reductive leaching with copper is reacted with the reduced mass generated after reduction roasting to precipitate the copper from the leach solution. Said cemented Cu obtained by the present process is characterized by SEM and EDAX data as shown in FIG. 3 and can be reused as a reductant in leaching again or it can be melted and purified for copper production. The removal of copper impurity from the solution helps in easy recovery of critical metals from the solution.

### Experimental Section

### Materials Involved

NMC black mass taken from spent batteries is involved for illustration of the process for the recovery of battery cathode metal oxides and copper from a cathode material in accordance with the present invention.

### EXAMPLE 1

2 g NMC black mass along with 20% excess of stoichiometric amount of (0.764 g) Cu powder and 20% excess of stoichiometric amount (4.8 g) H₂SO₄ was added to 25 ml of distilled water and stirred for 4 hours at 70° C. and 600 rpm. The leach liquor contained dissolved sulfate compounds. The pH of the leached solution was 1.19 and the ORP was 416 mV. The solution was then filtered.

For carbothermic reduction, 2 g NMC black mass and 0.4 g (100% excess) Activated charcoal were mixed and transferred into an alumina crucible and kept in the furnace in a closed atmosphere at 700° C. for 2 hours. Black mass was reduced to Ni-Co metal, MnO and Li₂CO₃. The residue weighed to be 2.16 g.

To recover Li, the reduced residue was water leached in 200ml distilled water at 90° C. for 1 hour in the presence of CO₂. The leached solution was then filtered and the residue was dried in the oven at 120° C. for 2 hours. The residue weighed to be 1.37 g.

1.09 g Ni—Co—MnO was added to the Cu leaching leach liquor to cement out Cu at 80° C., 600 rpm for 1 hour. The solution was filtered and the cemented Cu residue was weighed which came out to be 0.62 g.

### EXAMPLE 2

The anode of the battery, Cu foil coated with graphite, was cleaned properly to remove traces of graphite. Then the Cu foil was cut into 1 cm×1 cm sheets to be used as reductant for leaching process. 2 g NMC black mass along with 20% excess of stoichiometric amount of (0.764 g) Cu sheets and 20% excess of stoichiometric amount (4.8 g) H₂SO₄ was added to 25 ml of distilled water and stirred for 4 hours at 70° C. and 600 rpm. The leach liquor contained dissolved sulfate compounds. The pH of the leached solution was 1.9 and the ORP was 495 mV. The solution was then filtered.

For carbothermic reduction, 2 g NMC black mass and 0.4 g (100% excess) Activated charcoal were mixed and transferred into an alumina crucible and kept in the furnace in a closed atmosphere at 700° C. for 2 hours. Black mass was reduced to Ni—Co metal, MnO and Li₂CO₃. To remove Li, the reduced residue was water leached in the presence of CO₂.

0.77 g Ni—Co—MnO water leached residue was added to the Cu leaching leach liquor to cement out Cu. The solution was filtered and the residue was weighed which came out to be 0.61 g.

The above process may be carried out by involving 33% of the black mass from LCO batteries for reduction and remaining 67% of the mass for acid leaching. In case of NMC batteries, the ratio of black mass used may be increased to 40:60 or even higher.

### EXAMPLE 3

2 g NMC black mass along with 1.5 g PCB Cu (PCB scrap containing Cu) and 20% excess of stoichiometric amount (4.8 g) H₂SO₄ was added to 32.33 ml of distilled water and stirred for 4hours at 70° C. and 600 rpm. The leach liquor contained dissolved sulfate compounds. The solution was then filtered. Weight of the residue was ˜0.8 g.

0.6 g Co metal was added to the leach solution to cement out Cu. The pH of the leached solution was 2.18 and the ORP was 418 mV. Weight of the copper residue was 0.52 g.

Thus the above experiment shows that by following the present process, high temperature reduction step can be advantageously avoided by directly using Co metal containing source for cementation of copper.

### EXAMPLE 4

2 g LCO black mass along with 20% excess of stoichiometric amount of (0.764 g) Cu sheets (cut into 1 cm×1 cm), 0.15 g FeCl₃ (7.5% of Black Mass) which acts as catalyst and 50% excess of stoichiometric amount (6g) H₂SO₄ was added to 25.87 ml of distilled water and stirred for 2hours at 70° C. and 600 rpm. The leach liquor contained dissolved sulfate compounds. The pH of the leached solution was 0.59 and the ORP was 440 mV. The solution was then filtered.

For carbothermic reduction, 2 g LCO black mass 0.02 g Na₂CO₃ (catalyst) and 0.4 g (100% excess) Activated charcoal were mixed and transferred into an alumina crucible and kept in the furnace in a closed atmosphere at 650° C. for 2 hours. Black mass was reduced to Co metal and Li₂CO₃. The residue weighed to be 2.13 g.

To recover Li, the reduced residue was water leached in 200 ml distilled water at 90° C. for 1 hour in the presence of CO₂. The leached solution was then filtered and the residue was dried in the oven at 120° C. for 2 hours. The residue weighed to be 1.51 g.

0.77 g Co obtained from the previous step was added to the Cu leaching leach liquor to cement out Cu at 80° C., 500 rpm for 1 hour. The solution was filtered and the cemented Cu residue was weighed which came out to be 0.82 g (along with C weight).

EXAMPLE 5

2 g NMC black mass along with 20% excess of stoichiometric amount of (0.764g ) Cu powder and 20% excess of stoichiometric amount (4.8g) H₂SO₄ was added to 25 ml of distilled water and stirred for 4 hours at 70°° C. and 600 rpm. The leach liquor contained dissolved sulfate compounds. The pH of the leached solution was 1.19 and the ORP was 416 mV. The solution was then filtered.

The filtered solution was boiled to decrease the volume to 75% of the initial volume and cooled it to room temperature. Copper sulfate crystals were observed after 48 h.

### EXAMPLE 6

2 g NMC black mass along with 20% excess of stoichiometric amount of (0.764 g) Cu powder and 20% excess of stoichiometric amount (4.8g) H2SO4 was added to 25 ml of distilled water and stirred for 4 hours at 70° C. and 600 rpm. The leach liquor contained dissolved sulfate compounds. The pH of the leached solution was 1.19 and the ORP was 416 mV. The solution was then filtered. Weight of the residue was ˜0 g.

The filtered solution was electrolyzed with 2.2V using SS cathode and Pb anode. >90% of copper was selectively electrodeposited on the cathode without electrolyzing much of Co and Ni as shown in FIG. 4.

### Uniqueness of the Present Invention

The present invention provides a process for the recovery of battery cathode metal oxides and copper from a cathode material from waste lithium ion batteries involving unique process features of,
i) partial reduction of black mass for complete recovery of critical metals, thus reducing energy requirement of the process markedly.
ii) Use of Cu as a reductant in replacement of unstable and expensive H₂O₂ or impure Fe/Fe (II) salt which can be easily recovered from the solution for re-use in the purpose.

### No-Obviousness of the Present Invention From the Existing Prior Arts

The present invention particularly involves leaching of selectively about 20-80% of the black mass of said cathode material in the presence of copper as a reductant in the process step (a) and selective high temperature reduction of the remaining portion of said black mass of said cathode material in process step (b) to decrease the energy consumption strategically compared to the conventional high temperature reduction followed by leaching process. Involvement of Cu as intermediate reductant not only reduces expenditure and number of process steps thus enabling more economic process but also prevents hydrogen gas from escaping out.

### Advantages Obtained by the Present Invention

i) In the present process, the copper recovered can be reused as reductant in leaching step again or it can be melted and purified for copper production.

ii) Only 20-80% of the black mass is reduced at high temperature that decreases the energy consumption.

iii) The present work avoids the usage of unstable and expensive H₂O₂ or high temperature, instead involves more economical reductant, Cu from the anode of the battery which also reduces cost and number of process steps thus enabling more economic process.

iv) The present process enables recovery of transition metal salts which can be used in new battery manufacturing thus providing for recycling spent Lithium Ion Batteries in an energy-efficient and cost-effective technique.

1. A process for recovery of any one or more of transition metals including selected Ni, Co and Mn and also lithium from waste of lithium ion batteries, comprising:
subjecting at least a part of said waste of lithium ion batteries including said transition metals in a trivalent state to reductive leaching in mineral/organic acids in presence of copper as reductant in the temperature range of 0° C. to 100° C. for 5 minutes to 12 hours; and
thereafter, following said leaching step by solid liquid separation to remove the undissolved materials, if any, to get clear leach solution of anyone or more of Li, Ni, Co, Mn and containing Cu for desired recovery of the transition metal therefrom.

2. The process as claimed in claim 1, wherein about 20-80% of the said waste of lithium ion batteries is subjected to said step of reductive leaching in mineral/organic acids in presence of copper as reductant and the remaining part of the said waste of lithium ion batteries to a high temperature reduction by heating to a temperature in the range from 200° C. to 1100° C. for a duration from 5minutes to 12 hours using solid or gaseous reductants, thereby converting said remaining part of said waste of lithium ion batteries including said transition metals in a trivalent state to recoverable transition metal therefrom as a reduced mass; and
further water leaching of the reduced mass to recover lithium carbonate or hydroxide present in the reduced mass.

3. The process as claimed in claim 2, comprising the step of recovery of copper used as the reductant from the generated leach solution containing the transition metals following said copper based reductive leaching, wherein said reduced mass prior to or after water leaching is treated with said leach solution for desired cementation of the residue carried out at room temperature to 100° C. for a duration of 5 minutes to 12 hours, the said cementation step carried out below pH 5, preferably below pH 3 to avoid copper hydrolysis and also to promote the dissolution of MnO present in the residue.

4. The process as claimed in claim 1, comprising the steps of;
a) reductive leaching of part of said waste of lithium ion batteries cathode material with mineral or organic acids in presence of metallic copper to reduce the transition metals including Ni, Co, Mn in the cathode material from higher oxidation state to 2+ state, followed by separating the undissolved solids after leaching by subjecting said solids to a solid-liquid separation to recover pregnant solution;
b) reducing the remaining part of the said waste of lithium ion batteries cathode material with reducing agents such as carbon and/or hydrogen containing materials at high temperature, followed by subjecting the resultant reduced material to water leaching in presence or absence of CO₂ purging to generate a slurry for recovery of lithium out of said slurry through solid-liquid separation resulting to lithium containing solution and solid containing metallic nickel and/or cobalt and MnO; and
c) reacting the pregnant solution generated from step (a) with said solid generated from the step (b) to cement out or remove the copper from said pregnant solution and also enabling recovery of dissolved Ni, Co and Mn obtained from step (b) in the form of corresponding metal salts.

5. The process as claimed in claim 1, comprising reductive leaching of selectively about 20-80% of said waste of lithium ion batteries cathode material in the presence of reductant anode copper or copper scrap as a reductant from the battery and thereafter, reducing selectively of the remaining 20-80% of said waste of lithium ion batteries cathode material at high temperature to decrease the energy consumption compared to the conventional high temperature reduction followed by leaching process.

6. The process as claimed in claim 1, comprising the steps of:
(a) reductive leaching of selectively about 60% of said waste of lithium ion batteries cathode material in mineral/organic acids in presence of copper in the temperature range of 0° C. to 100° C. for 5 minutes to 12 hours to reduce the transition metals including Ni, Co, Mn in said cathode material from higher oxidation state to 2+ state, followed by removal of the undissolved materials through solid liquid separation technique, to obtain the clear leach solution containing Li, Ni, Co, Mn and/or Cu.
(b) heating in a high temperature carbothermic reduction step, the remaining 40% of said waste of lithium ion batteries to a temperature in the range from 200° C. to 900° C. for duration from 5 minutes to 12 hours in presence of solid or gaseous reductants to convert the trivalent transition metal oxides to divalent or zero-valent transition metals required for step (c); and
subjecting the resultant reduced material to water leaching in presence or absence of CO₂ purging to generate a slurry for recovery of lithium out of said slurry through solid-liquid separation resulting to lithium containing solution and solid containing metallic nickel and/or cobalt and MnO; and
(c) a cementation step, the leach solution from step (a) is treated with the residue obtained from step (b) to recover the copper;
wherein, said cementation process is carried out at room temperature to 100° C. for a duration of 5 minutes to 12 hours at pH of below 5 to avoid copper hydrolysis and also to promote the dissolution of MnO present in the residue of step (b);
wherein after said cementation, copper is removed by solid-liquid separation step providing more than 98% recovery of Li and said transition metals Ni, Co and Mn from the waste of lithium ion batteries;
wherein said cementation step, cementation is carried out with any nickel and/or cobalt containing materials/scrap;
wherein said reduction roasting of only 40% of said waste of lithium ion batteries saves 60% of energy requirement compared to the conventional high temperature reduction followed by leaching process.

7. The process as claimed in claim 6, wherein said high temperature carbothermic reduction step involves solid or gaseous reductants including carbohydrates, hydrocarbons, hydrogen, coal, coke.

8. The process as claimed in claim 1, wherein copper is recovered from the solution obtained after reductive leaching step by selective crystallization of copper sulfate crystals by evaporating water or by selective Electrowinning by maintaining the voltage below 3.5 V.

9. The process as claimed in claim 6, wherein copper is recovered from the solution obtained after reductive leaching step by cementation with any nickel and/or cobalt containing materials/scrap;
wherein said Nickel/cobalt containing materials/scrap is selected from the sources including nickel/cobalt recovered from Li-ion batteries, nickel/cobalt containing scrap such as mu metal, Sm-Co magnet, maraging steel, pharmaceutical or petrochemical catalysts or any other nickel/cobalt containing materials.

10. The process as claimed in claim 6, wherein the cemented copper is involved in reductive leaching step as a reductant and/or is purified by smelting-refining or other conventional processes.

11. The process as claimed in claim 1, wherein Ni, Co, Mn and Li are recovered from the resultant solution by conventional purification processes including precipitation, solvent extraction, ion exchange.

12. The process as claimed in claim 1, wherein the copper reductant involved in reductive leaching step is selected from the sources including copper from Li-ion batteries, copper generated by cementation step, copper powder, copper containing alloys, PCBs, electronic waste or any other copper containing materials.

13. The process as claimed in claim 1, wherein the waste of lithium ion batteries comprising of particulate material provided is obtained from lithium containing transition metal (Ni, Co, Mn) oxide material having the chemical formula: LiMO₂ or Li₂O.M₂O₃ and wherein said material may stem from spent batteries, waste battery material from production and off-spec material and also materials containing lithium and said transition metals.

14. The process as claimed in claim 1, wherein the undissolved material generated when PCBs or electronic waste are used as a copper reductant, which is rich in precious metals, can be processed for the recovery of precious metals using conventional methods.
